(19) United States
(12) Patent Application Publication
(10) Pub. No.: US 2026/0164327 A1
(43) Pub. Date: Jun. 11, 2026

(54) Handover Management System and User Device

(71) Applicants: Koninklijke KPN N.V., Rotterdam (NL); Nederlandse Organisatie Voor Toegepast-Natuurwelenschappelijk Onderzoek TNO, 's-Gravenhage (NL)

(72) Inventors: Toni Dimitrovski, Boskoop (NL); Prachi Sachdeva, Den Hoorn (NL)

(21) Appl. No.: 19/105,270

(22) PCT Filed: Sep. 15, 2023
(86) PCT No.: PCT/EP2023/075430

§ 371 Date: Feb. 20, 2025

(30) Foreign Application Priority Data
Sep. 20, 2022 (EP) 22196648

(51) Int. Cl. H04W 36/14; H04W 36/00; H04W 36/08; H04W 36/30; H04W 36/32; H04W 88/06

(52) U.S. Cl. CPC H04W 36/1446; H04W 36/00835; H04W 36/08; H04W 36/304; H04W 36/322; H04W 88/06

(57) ABSTRACT

The disclosure pertains to a handover management system for managing handover of a first user device between a dedicated network comprising at least one dedicated base station and a public network comprising a plurality of public base stations and to a user device for use with such a system. The wireless coverage areas of the dedicated network and the public network overlap at least in part. The handover management system comprises a receiving system configured to receive a first set of radio signal parameter values from the first user device for the at least one dedicated base station and at least one public base station of the plurality of public base stations. The handover management system contains service area information representative of a dedicated service area of the dedicated network defined on the basis of a plurality of second sets of radio signal parameter values of the at least one dedicated base station and the at least one public base station. The handover management system is configured to initiate handover of the first user device from the dedicated network to the public network only when the first set of radio signal parameter values indicates location of the first user device is outside the dedicated service area based on the service area information.

### TECHNICAL FIELD

The present disclosure relates to a handover management system and a user device. In particular, the disclosure relates to a handover management system and user device for use in such a system, wherein the system is for managing handover of a first user device between a dedicated network comprising at least one dedicated base station and a public network comprising a plurality of public base stations, wherein wireless coverage areas of the dedicated network and the public network overlap at least in part.

### BACKGROUND

A public wireless communication network contains a plurality of public radio base stations or cells that provide a wireless coverage area to facilitate communication of mobile devices for subscribers of the operator of the public network. An essential element of this mobility is handover, wherein mobile devices are connected subsequently or simultaneously to multiple radio base stations or cells of the public network. In some wireless communication networks, a mobile device measures a radio signal parameter value from one or more public radio base stations and reports the measured values to the serving public radio base station to determine whether this serving radio base station is appropriate. Handover may be triggered when a neighbour radio base station or cell becomes better, possibly using a set threshold, than the serving base station or cell. The use of a threshold that is to be exceeded before handover is performed can be used to avoid frequent handovers between neighbouring base stations or cells when the measured radio signal parameter values of these base stations or cells are approximately equal.

Recent years have seen the development of dedicated wireless communication networks providing a wireless coverage area that may overlap with the coverage area of a public wireless communication area. Such dedicated networks are not open to everyone willing to take a subscription as for a public telecommunications network but limit access to specific user groups. Such networks include in-home networks, private networks (e.g. a factory network), or even a private part of a public network, such as a network slice of a 5G telecommunications network, etc. These dedicated networks offer wireless coverage through one or more dedicated radio base stations that may be connected to a public wireless communication network via a gateway device. User devices connected to a dedicated network may be handed over to the public network based on the same mechanism as handover between public base stations or cells within the public telecommunications network.

### SUMMARY

The inventors have recognized that the handover mechanism as applied within a public telecommunications network may be less suitable for handover of a user device from a dedicated network to a public network. In some instances, it is preferable for a user device wirelessly connected to a dedicated base station to maintain the connection to that dedicated network for using services within that dedicated network even when radio signal parameter values indicate that a better wireless connection is available with the public network.

To that end, one aspect of the present disclosure pertains to a handover management system for managing handover of a first user device between a dedicated network comprising at least one dedicated base station and a public network comprising a plurality of public base stations, wherein wireless coverage areas of the dedicated network and the public network overlap at least in part. The handover management system may comprise a receiving system configured to receive a first set of radio signal parameter values from the first user device for the at least one dedicated base station and at least one public base station of the plurality of public base stations. The handover management system may also contain service area information representative of a dedicated service area of the dedicated network defined on the basis of a plurality of second sets of radio signal parameter values of the at least one dedicated base station and the at least one public base station. Furthermore, the handover management system may be configured to initiate handover of the first user device from the dedicated network to the public network only when the first set of radio signal parameter values indicates location of the first user device is outside the dedicated service area based on the service area information in, for example, a storage system.

The handover management system allows to control handover by estimating location of a user device to be within or outside of a dedicated service area based on radio signal parameter values that may be used as a kind of coarse coordinate system for handover purposes. When the handover management system estimates that the user device is located in the dedicated service area, communication with the dedicated network may be maintained even when the radio signal parameter values of the public network for the user device indicate that a better radio connection would be available with the public network. Handover to the public network may be performed when the location of the user device is estimated to be outside (or logically equivalent, estimated to be not inside) of the dedicated service area. However, when the user device approaches the dedicated network from the public network, handover to the dedicated network may be conducted based on the best signal strength according to the prior art method described in the background. Hence, the handover management system may control handover between the dedicated network and the public network asymmetrically.

It should be appreciated that the service area information may be stored in a storage system or memory system of the handover management system, for example in a system of a dedicated base station or in a system connected to a dedicated base station.

It should also be appreciated that the handover management system allows to define the dedicated service area in an arbitrary manner. One example is to define the dedicated service area within boundaries formed by the walls of a house or other indoor building or along the perimeter of an area containing the house or building, e.g. a garden or factory area. However, more complicated dedicated service areas can be envisaged, such as areas within a building, for example some particular rooms of a building wherein continued connection with the dedicated network is particularly preferred.

It should also be appreciated that both the public network and dedicated network may comprise 3GPP 5G networks.

It should also be appreciated that the dedicated base stations may comprise wireless access points. Such wireless access points may apply a radio access technology, for example WiFi, different from the radio access technology of the public radio base stations.

Finally, it should be appreciated that the radio signal parameter values may comprise values that are measured from radio signals received from public and/or dedicated base stations. The first set of radio signal parameter values may comprise a set of dynamically changing parameter values of the radio signals that are momentarily measured during normal operation of a user device (or averages of a few measurements) and reported to a base station. The second sets of radio signal parameter values may comprise a more sizeable number of measurements that may be relatively static, compared to the first set, to define the dedicated service area.

In one embodiment, the radio signal parameter values of the first and second sets comprise reference signal received power, RSRP, measurements. RSRP measurements (typically expressed in dBm) are frequently used in telecommunications for handover decisions and provide for a relatively simple implementation for the disclosed handover system. It should be appreciated that other parameters may be used as an alternative or in addition, such as reference signal received quality, RSRQ, and/or reference signal signal-to-interference (RS-SINR), typically expressed in dB, to estimate location of the user device, although some additional processing of these parameter values may be required.

In one embodiment, the handover management system is configured to use service area information that may comprise a machine learning model. The model may be trained using at least the second sets of radio signal parameter values. In this manner, the trained model may estimate when the user device is outside the dedicated service area by inputting the first set of radio signal parameter values in the trained machine learning model and the output indicates whether the first user device is located outside the dedicated service area. The machine learning model may be applied to obtain more accurate estimations of the location of the user device vis-à-vis the dedicated service area. Application of the model may, for example, be useful when higher accuracy is required or for more complicated dedicated service areas. In one further embodiment the output of the machine learning model is a binary output indicating location of the first user device inside or outside of the dedicated service area and the model is trained in addition using at least a third sets of radio signal parameter values of the at least one dedicated base station and the at least one public base station outside of the dedicated service area. It should be appreciated that for gathering the third sets of radio signal parameter values, the first user device or other user device may assume a different mode than the service area definition mode for registering the dedicated service area.

In one embodiment, the handover management system is configured to use service area information that may comprise a representation of the second sets of radio signal parameter values enabling evaluation against the first set of radio signal parameter values to estimate whether the first user device is located outside the dedicated service area. In this embodiment, the second sets of radio signal parameters may be processed with one or more mathematical operations to obtain the service area information. The service area information may, for example, comprise values, boundary values, intervals, or any other representation of the second sets of radio signal parameter values suitable to define the dedicated service area and to estimate location of the user device vis-à-vis the dedicated service area. In one embodiment, the evaluation may comprise a comparison of the first set of radio signal parameter values with a representation of the second sets of radio signal parameter values to estimate whether the first user device is located outside the dedicated service area.

In one embodiment, the handover management system is configured to acquire the second sets of radio signal parameter values for defining the dedicated service area from at least one of the first user device or another user device in service area definition mode. The embodiment allows the user to define the dedicated service area, wherein the connection with the dedicated network is to be maintained. To that end, a user device may be set to a service area definition mode as will be explained in further detail below. In one example, the user may traverse a trajectory with a user device in service area definition mode in the wireless coverage area of the dedicated network to define the dedicated service area. During this operation, the user device may gather several second sets of radio signal parameter values, such as RSRP values, each set comprising values from both one or more dedicated base stations and from one or more public base stations, and report these to the handover management system. The handover management system may subsequently process these values for obtaining the service area information.

It should be appreciated that the user device in service area definition mode may be a device that is also used for communication with the dedicated network after defining the dedicated service area, such as the first user device mentioned above, or a special purpose device for defining the dedicated service area.

In one embodiment, the handover management system is configured to send a service area definition mode instruction to the first user device or the other user device. This embodiment enables control from the handover management system to set one or more user devices to service area definition mode. In one embodiment, the service area definition mode instruction provides a report time interval for the first user device and/or the other user device to report the second sets of radio signal parameter values. The report time interval may be different from report time intervals of radio signal parameter values for handover in normal operation, for example for the first radio signal parameter values, in order to obtain an appropriate definition of the dedicated service area.

In one embodiment, the handover management system may be configured to be set to a service area definition mode to acquire the second sets of radio signal parameter values for defining the dedicated service area. The handover management system in service area definition mode may be configured to disable handover of the first user device or the other user device to the at least one public network base station. The embodiment facilitates that, when definition of the service area is in progress, the handover management system does not command the user device collecting the second sets of radio signal parameter values to connect to a public base station but to maintain connection to the dedicated base station so that the handover management system may collect the second sets.

It should also be appreciated that the handover measurement system is configured to terminate the service area definition mode for itself and/or in the user device.

Dedicated networks with a large service area and dedicated networks having higher frequency base stations may have deployed a plurality of dedicated base stations. In one embodiment, the dedicated network comprises at least a first dedicated base station and a second dedicated base station. The handover management system may be configured to initiate handover of the first user device from the first dedicated base station to the second dedicated base station based on receiving a first radio signal parameter value for the first dedicated base station and a second radio signal parameter value for the second dedicated base station and comparing these values. The embodiment allows handover between dedicated base stations to be performed according to conventional handover mechanisms, so that user devices communicating within the dedicated network may be served by the base station with the best radio connection. Again, as within public networks, a threshold may be applied to avoid frequent handover between dedicated base stations when a user device measures approximately equal radio signal parameter values.

In one embodiment, the handover management system may be configured to recognize at least one base station, such as the dedicated base stations, on the basis of a closed access group identifier, CAG ID, or a preconfigured list of dedicated cell identifiers, cell IDs of dedicated base stations. The identifier may assist in controlling access to the dedicated network and may assist the handover management system to distinguish between radio signal parameter values for dedicated base stations and public base stations when deciding on the handover for the user device, for example from one dedicated base station to another dedicated base station when conventional handover decision making may need to be applied. In one further embodiment, the handover management system may also provide the identifier(s) to the user device in service area definition mode. Such an identifier may be included, for example, in a service area definition instruction. The identifier(s) may serve to inform the user device for which base stations radio signal parameter values for the second set should be measured.

The handover management system and/or the user device may be set to the service area definition mode in various ways.

In one embodiment, the handover management system may be configured to be set to a service area definition mode to acquire the second sets of radio signal parameter values. The handover management system may be configured to be set to this mode in response to receiving a service area definition mode instruction from a user device. This embodiment enables a user to control when to define the dedicated service area.

For dedicated networks comprising more than one dedicated base station, one embodiment pertains to the first dedicated base station being configured to communicate setting service area definition mode to the second dedicated base station. Such communication may be conducted over direct connections between the dedicated base stations or via the public network. The embodiment facilitates service area definition mode behavior for all dedicated base stations of the dedicated network. Such service area definition mode behavior comprises collecting and/or processing second sets of radio signal parameter values to define the dedicated service area, for example by training a machine learning model or to obtain a representation of such a dedicated service area.

The handover management system and/or the user device may store, use or distribute the second sets of radio signal parameter values in various ways.

For dedicated networks comprising more than one dedicated base station, one embodiment pertains at least a first dedicated base station and a second dedicated base station being configured to store the second sets of radio signal parameter values received from the first user device or another user device at least during service area definition mode. Since a user device reports the second sets of radio signal parameter values to the serving dedicated base station, both the first dedicated base station and the second dedicated base station may receive second sets of radio signal parameter values. To define the dedicated service area, it is advantageous that the dedicated base stations of the dedicated network store these values to allow defining the dedicated service area when the user device has finished measurements.

In one embodiment, at least the first dedicated base station and the second dedicated base station may exchange second sets of radio signal parameter values with each other. The embodiment enables multiple or each dedicated base station to obtain all the second sets of radio signal parameter values for the dedicated base stations of the dedicated network, so that each individual base station can obtain the service area information for the full service area.

In one embodiment, the first dedicated base station and the second dedicated base station may send the second sets of radio signal parameter values to a central location or to the user device. This facilitates centralization of the service area information for centralized handover management or enable distribution of the second sets of radio signal parameter values by the user device.

In one embodiment, the first dedicated base station may be configured to obtain service area information representative of a dedicated service area of the first dedicated base station of the dedicated network on the basis of the received second sets of radio signal parameter values. Likewise, the second base station may be configured to obtain service area information representative of a dedicated service area of the second dedicated base station of the dedicated network on the basis of the received second sets of radio signal parameter values. This embodiment facilitates decentralized handover control by making only a part of the service area information available to a particular dedicated base station, so that a decentralized handover management system may be obtained.

The handover management system and/or the user device may terminate the service area definition mode in various ways. Termination of the service area definition mode enables activating the handover management system to decide on handover of user devices based on the service area information by estimating the location of the user device.

In one embodiment, the handover management system is configured to receive a service area definition mode termination instruction from a user device. The embodiment facilitates user control to switch the handover management system back to normal operation using the acquired service area information for handover decisions.

In one embodiment, the handover management system is configured to terminate the service area definition mode. The handover management system may, for example, monitor expiry of a definition mode timer and/or analyze the second sets of radio signal parameter values to decide on termination of the service area definition mode.

For dedicated networks comprising more than one dedicated base station, one embodiment, pertains to the handover management system being configured to communicate the termination of the service area definition mode from a dedicated base station to one or more other dedicated base stations of the dedicated network. This embodiment may be advantageous when the dedicated base stations in the dedicated network are aware of each other's existence and are communicatively connected to each other.

One other embodiment involves the handover management system being configured to store information from which dedicated base station a user device entered a cell of a dedicated base station in service area definition mode and forwarding a service area definition mode termination indication in accordance with this information. The embodiment enables forwarding the service area definition mode termination indication back along and in the order of the dedicated base stations to which the user device connected in service area definition mode, when the user device sends the service area definition termination instruction to the dedicated base station to which it is connected upon termination. This is advantageous for a dedicated network wherein the dedicated base stations are not aware of each other's existence in the network.

In one embodiment, the handover management system may be part of at least one dedicated base station. The handover management system may, for example, be implemented in one dedicated base station, be distributed over two or more dedicated base stations of the dedicated network or be a part of a management system for base stations.

One further aspect of the present disclosure relates to a user device configured for use with the handover management system as disclosed herein. Particularly, the user device may be configured to be set to a service area definition mode for transmitting the second sets of radio signal parameter values to the handover management system. The user may traverse a trajectory with a user device in service area definition mode in the wireless coverage area of the dedicated network to define the dedicated service area. During this operation, the user device may gather several second sets of radio signal parameter values, such as RSRP values, from both one or more dedicated base stations and from one or more public base station, and report these to the handover management system. The handover management system may subsequently process these values for obtaining the service area information.

In one embodiment, the user device may be configured for transmitting at least one identifier of at least one dedicated base station, such as a closed access group identifier, CAG ID, or a group of cell IDs to the handover management system. The identifier assists the handover management system to distinguish between radio signal parameter values for dedicated base stations and public base station when deciding on the handover for the first user device in normal operation.

In one embodiment, the user device is configured to be set to the service area definition mode in response to at least one of a service area definition mode instruction from the handover management system and a user input on the user device. The embodiment enables to use a user device for both service area definition mode for defining the dedicated service area and for normal operation.

In one embodiment, the user device may be configured to store sets of radio signal parameter values during service area definition mode and to send the sets to the handover management system after storage. The embodiment facilitates gathering the second sets of radio signal parameter values at the user device for multiple dedicated base stations and providing these sets to the handover management system at an appropriate time, e.g. when connection to a dedicated base station is bad or temporarily lost or when a dedicated base station cannot be reached because the user device is out of the wireless coverage area of the dedicated base station. The embodiment also facilitates gathering third sets of radio signal parameter values of the at least one dedicated base station and the at least one public base station outside of the dedicated service area. The third sets of radio signal parameter values of the at least one dedicated base station and the at least one public base station may be gathered outside of the dedicated service area. The embodiment avoids that measures should be taken to obtain the third sets of radio signal parameter values from the public network. It should be appreciated that for gathering the third sets of radio signal parameter values, the first user device or other user device may assume a different service area definition mode than for registering the dedicated service area.

In one embodiment, the user device may be configured to receive and process one or more CAG IDs used in the dedicated network and/or a list of cell IDs used for dedicated base stations from the handover management system. Such an identifier or identifiers may be contained in a service area definition mode instruction received from a dedicated base station. The identifier or identifiers may serve to inform the user device for which dedicated base station(s) radio signal parameter values should be gathered for the second sets.

Yet another aspect of the present disclosure relates to a telecommunications system comprising a public network, at least one dedicated network, a handover management system and at least one user device, wherein wireless coverage areas of the dedicated network and the public network overlap at least in part. The handover management system may be configured for managing handover of a first user device between the dedicated network comprising at least one dedicated base station and the public network comprising a plurality of public base stations. The handover management system may comprise a receiving system configured to receive a first set of radio signal parameter values from the first user device for the at least one dedicated base station and at least one public base station of the plurality of public base stations. The handover management system may also contain service area information representative of a dedicated service area of the dedicated network defined on the basis of a plurality of second sets of radio signal parameter values of the at least one dedicated base station and the at least one public base station. Furthermore, the handover management system may be configured to initiate handover of the first user device from the dedicated network to the public network only when the first set of radio signal parameter values indicates the location of the first user device is outside the dedicated service area based on the service area information. The at least one user device may be configured to be set to a service area definition mode for transmitting the second sets of radio signal parameter values to the handover management system. A user may traverse a trajectory with the at least one user device in service area definition mode in the wireless coverage area of the dedicated network to define the dedicated service area.

Another aspect of the disclosure relates to a method for managing handover for a first user device between a dedicated network comprising at least one dedicated base station and a public network comprising a plurality of public base stations, wherein wireless coverage areas of the dedicated network and the public network overlap at least in part. The method involves a step of receiving a first set of radio signal parameter values from the first user device for the at least one dedicated base station and at least one public base station of the plurality of public base stations. The method may also involve obtaining service area information representative of a dedicated service area of the dedicated network defined on the basis of a plurality of second sets of radio signal parameter values of the at least one dedicated base station and the at least one public base station. The method may further involve a step of initiating handover of the first user device from the dedicated network to the public network only when the first set of radio signal parameter values indicates location of the first user device is outside the dedicated service area based on the service area information in, for example, a storage system.

Yet another aspect of the disclosure involves a method in a user device for use in the method for managing handover set out in the previous paragraph. The method involves the step of setting the user device in a service area definition mode for transmitting the second sets of radio signal parameter values to a handover management system.

Other aspects of the present disclosure include a computer program comprising software code portions that, when run on a computer system, cause the computer system to execute one or more steps of the method for managing handover or cause the computer system to execute one or more steps of the method for setting the user device in the service area definition mode.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object-oriented programming language such as Java, Smalltalk, C++ or the like and conventional procedural programming languages, such as “h” “C” programming language or similar programming languages. The program code may execute entirely on the person's computer, partly on the person's computer, as a stand-alone software package, partly on the person's computer and partly on a remote computer, or entirely on the remote computer or server. In the latter scenario, the remote computer may be connected to the person's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided.

Elements and aspects discussed for or in relation with a particular embodiment may be suitably combined with elements and aspects of other embodiments, unless explicitly stated otherwise.

Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 is a schematic illustration of a few public base stations of a public telecommunications network providing cells overlapping dedicated telecommunications networks having at least one dedicated base station;

FIG. 2 is a detail of FIG. 1 illustrating inefficient traffic flow when a user device is connected to a public base station while consuming a service from the dedicated network;

FIG. 3 is a schematic illustration of an embodiment of a handover management system for managing handover of a user device between a dedicated network comprising at least one dedicated base station and a public network comprising a plurality of public base stations;

FIG. 4 is a signaling flow chart showing some steps for the handover management system and user device for use with the handover management system;

FIG. 5 is a schematic illustration of an embodiment of a user device for use with a handover management system;

FIGS. 6A and 6B are schematic illustrations of a practical example of operation of the handover management system and user device;

FIG. 7 is a schematic illustration of an embodiment of a handover management system and user device for use with the handover management system for a dedicated network having a plurality of dedicated base stations; and

FIG. 8 depicts a processing system according to an embodiment for a handover management system or user device for use with the handover management system.

### DETAILED DESCRIPTION OF THE DRAWINGS

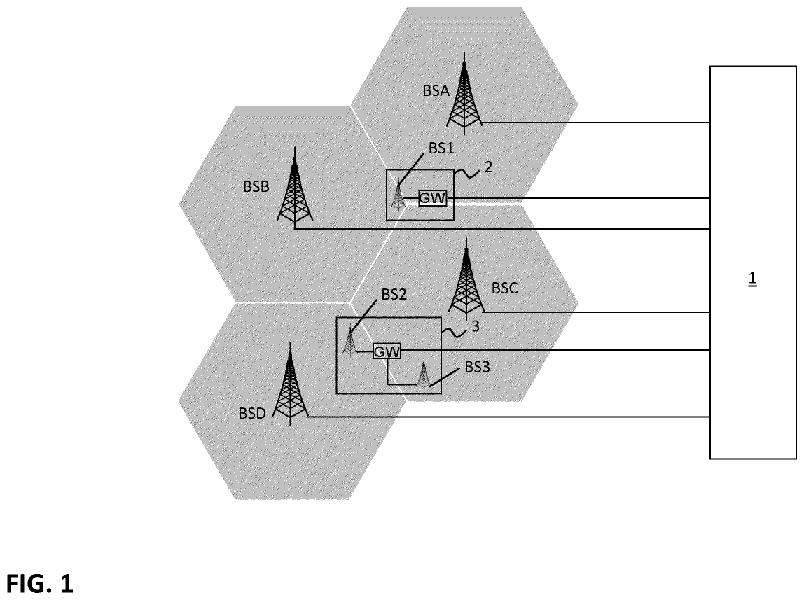

FIG. 1 is a schematic illustration of a public telecommunications network showing a few public base stations BSA-BSD connected to a core network system 1. The base stations BSA to BSD define a plurality of cells for a wireless coverage area. The terms base station and cell will be used interchangeably in the present disclosure.

In one example, the public telecommunications network is a 5G telecommunications network as defined by 3GPP. The 5G telecommunications network is composed of a 5G access network and a 5G core network (5GC) 1. The access network is made up of a new-generation radio access network (NG-RAN) which uses the 5G new radio interface (NR). The NG-RAN comprises 5G base stations such as BSA to BSD, also referred to as gNBs, which are connected to the 5 GC 1 and to each other. The higher frequencies of 5G networks reduces the range of the 5G base stations BSA-BSD. In order to provide continuous coverage, the public base stations BSA-BSDs are placed closer together and thus the density of public base station increases. As a result, more adjacent public base stations overlap, and users will be more likely to be under coverage from multiple public base stations (from other cells).

Dedicated networks are deployed within the coverage area of base stations BSA to BSD. The dedicated networks comprise base stations BS1, BS2 and BS3 and are connected via a gateway GW to the public telecommunications network in a wired or wireless fashion. The wireless coverage areas of the base stations BS1-BS3 of the dedicated networks overlap with the wireless coverage area of the public base station BSA-BSD and may span a particular area 2, 3, such as a house, office or factory site. Such base stations BS1-BS3 may also be constituted by wireless access points applying a radio access technology different from public radio base stations BSA-BSD.

Dedicated networks include in-home networks, private networks (e.g. a factory network), or even a private part of a public network, such as a network slice of a 5G telecommunications network, etc. These dedicated networks offer wireless coverage through one or more dedicated base stations BS1-BS3 that may be connected to a public wireless communication network via a gateway device GW. User devices connected to a dedicated network may be handed over to the public network based on the same mechanism as handover between public base stations or cells within the public telecommunications network.

One example of a dedicated network is a private network, such as a home network, office network or factory network. For example, with the rise of home automation and Personal IoT, more and more traditional non-networked home devices can become networked and be used and managed via remote monitoring, e.g. with a mobile app in a user device UE. In addition to the existing applications (e.g. printers, computers, smartphones), home networks may also be used for other home elements, such as entertainment (e.g. smart television, audio and game consoles), lighting, security and climate systems (i.e. environmental conditioning). These local devices may be connected via a (converged) home network and be provided as local services via a local UPF residing in the home. The user may use these home services through the converged home network, while also having access to the public network (i.e. internet), by being connected to the home UPF via a local base station BS1, BS2, BS3 (also referred to as home gNB). This may lead to lower user costs, higher performance and more privacy protection as the home services are used within the (local) home network.

The dedicated base stations BS1-BS3 may provide 5G small cells, which are easily deployed and may help to fill coverage gaps between large 5G base stations BSA-BSD of the public telecommunications network supplementing the coverage of macro sites. These dedicated networks may have a smaller coverage area depending on signal strength and aim to only provide in home connectivity. However, since radio signals attenuate through different surfaces, they may not follow a particular geographical shape.

Mobile user devices may be handed over from a base station BS1, BS2, BS3 of the dedicated network to a base station BSA-BSD of the public network based on received signal strength at a particular moment in time. This signal strength is generally measured on a pilot signal or reference signal emitted from the various base stations. Handover may occur more easily when the user device is around the border of the house area 2, i.e. in the garden or in the attic of the house if far from the dedicated base station BS1, BS2 or BS3.

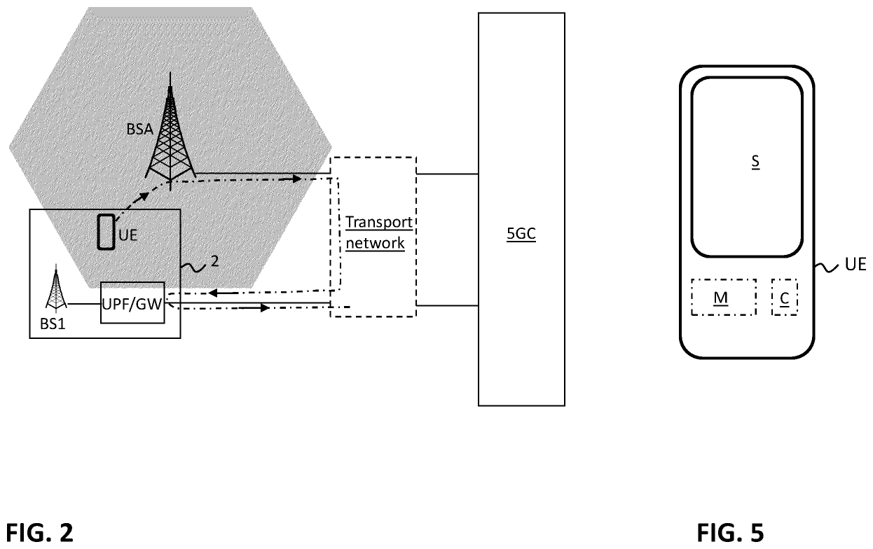

As shown in FIG. 2, when a user device UE is in the home network, it is connected via a base station BS1 and a UPF/GW to a core network of a network operator. The UE uses local services (e.g. home services) via the UPF within the home area depicted on FIG. 1. While the UE is connected via the in-home base station BS1, the UE is configured to measure certain radio signal parameter values from the currently serving cell of base station BS1 and surrounding cells, such as the base stations of the public network, e.g. base station BSA to estimate whether another cell/base station might be a more suitable access for the UE. These measurements may include at least one of Reference Signal Received Power (RSRP), Quality (RSRQ) and signal to interference ratio (RS-SINR), expressed in dB (or dBm in case of RSRP). The measurements are periodically sent to the currently serving base station, i.e. base station BS1, and BS1 determines whether to do a handover based on these measurements.

The handover procedure may be triggered when the neighbor cell, in this case of the public network provided by base station BSA, becomes better than the currently used cell, or when the value for the current cell falls below a given threshold and the neighbor cell performs better than that or another given threshold. If the base station BS1 decides to perform a handover procedure to public base station BSA, e.g. because the received signal power of the outside BSA is stronger than the currently used BS, it sends a handover request to the public base station BSA and triggers a RAN Handover Initiation towards the UE, in which case the UE detaches from base station BS1 and synchronizes to the new base station BSA. After the handover procedure, the UE is connected to the public base station BSA. In this case, the UE uses the local services in the home area 2 via the public base station BSA, which routes the connection through the operator transport network towards the UPF/GW. Since usually there is no direct operator transport network between BSA and the home this becomes even less optimal, as illustrated with the dashed-dotted line in FIG. 2.

Thus, while the UE is still in the house area 2 and using home services, the UE is now connected to the public base station BSA and the public base station BSA routes the user plane traffic through a transport network of an operator, only to go back towards the home UPF to use the local services. Even though the UE may be geographically in the wireless coverage area of the home network, the handover causes the data to go through a different and often longer path, instead of direct use. This is inefficient because the UE traffic is transported twice instead of once, as it goes through operator backhaul because the user plane is first carried from the public base station BSA to the home UPF (first transport), and then from the home UPF to the public UPF (second transport) in the 5GC. Furthermore, traffic is less private than necessary, and performance could be impacted, due to e.g. delay time.

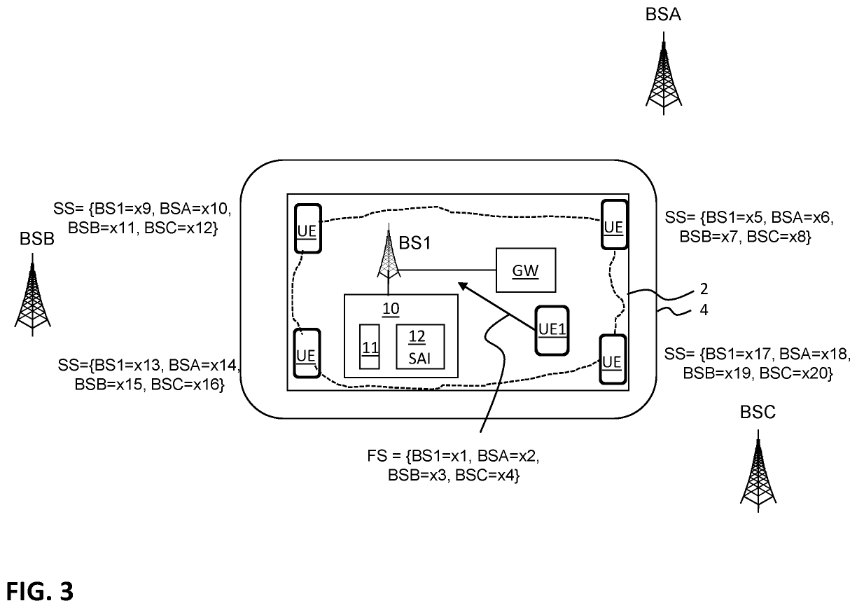

FIG. 3 is an embodiment of a handover management system 10 that allows a user device UE1 to continue using the local services via the dedicated base station BS1. However, when UE1 actually leaves the home area 2 (for example, the user device UE1 leaves the house), it is useful to perform the handover to a base station of the public network to continue the service. Furthermore, when UE1 re-enters the home area 2 or is close to that area such that the dedicated network provides a suitable connection, UE1 should be handed over to the dedicated network based on the regular radio signal parameter value comparison. The handover management system 10 according to the present disclosure is therefore especially suitable for a decision on whether to perform a handover from a dedicated base station BS1 to a public base station BSA-BSD and such decision is based on the estimated location of the UE within the service area.

The handover management system 10 comprises a receiving system 11 configured to receive a first set FS={x1, x2, x3, x4} of radio signal parameter values of the user device UE1 for the at least one dedicated base station BS1 and the other public base stations BSA-BSC of the public telecommunications network for which these values are measured. In particular, the user device UE may measure radio signal parameter value x1 from dedicated base station BS1, x2 from public base station BSA, x3 from public base station BSB and x4 from public base station BSC.

The handover management system 10 may also comprise or be connected to a storage system or memory system 12 storing service area information SAI representative of a dedicated service area 2 of the dedicated network defined on the basis of a plurality of second sets SS of radio signal parameter values of the at least one dedicated base station BS1 and the public base stations BSA-BSC at different locations throughout the service area 2 as will be described in further detail below. Furthermore, the handover management system 10 may be configured to initiate handover of the user device UE1 from the dedicated network to the public network only when the first set FS of radio signal parameter values indicates location of the user device UE1 outside the dedicated service area 2 based on the service area information SAI in the storage system 12.

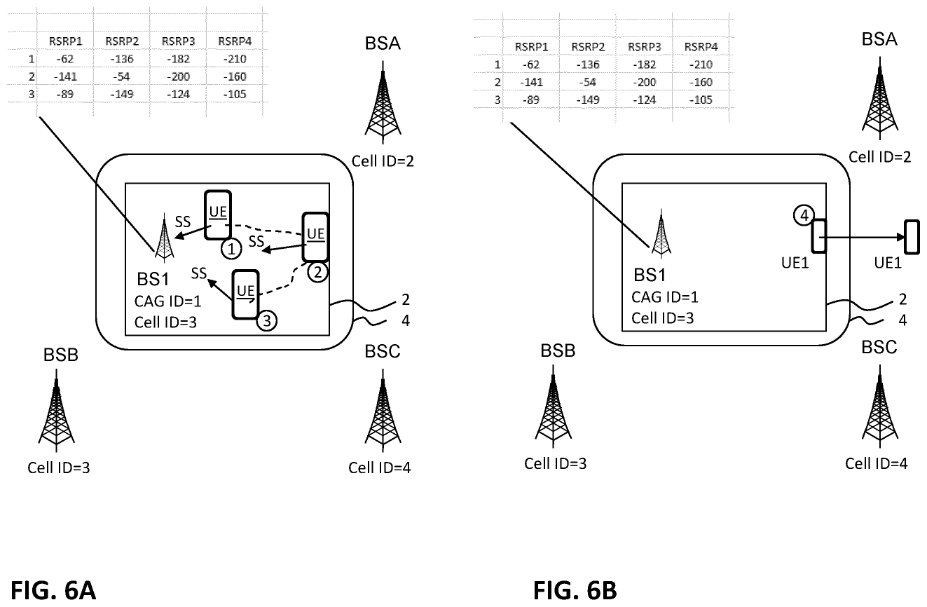

The handover management system 12 allows to control handover by estimating location of a user device UE1 to be within or outside of a dedicated service area 2 based on radio signal parameter values x that may be used as a kind of coarse coordinate system for making handover decisions. When the handover management system estimates that the user device UE1 is located in the dedicated service area 2, communication with the dedicated network may be maintained even when the radio signal parameter values x of the public network, i.e. base stations BSA, BSB or BSC, for the user device UE1 indicate that a better radio connection would be available with the public network. Handover to the public network may be performed when the location of the user device UE1 is estimated to be outside of the dedicated service area 2 as will be described in more detail with reference to FIG. 6B.

It should be appreciated that the handover management system allows to define the dedicated service area in an arbitrary manner. One example is to define the dedicated service area within boundaries formed by the walls of a house 2 or other indoor building or along the perimeter of an area containing the house or building, e.g. a garden 4 or factory area. However, more complicated dedicated service areas can be envisaged, such as areas within a building, for example some particular rooms of a building wherein continued connection with the dedicated network is particularly preferred.

Whereas FIG. 3 shows that the handover management system is connected to the dedicated base station BS1, it may be that the handover management system 10 is part of at least one dedicated base station. The handover management system 10 may, for example, be implemented in one dedicated base station BS1 or be distributed over two or more dedicated base stations of the dedicated network or be implemented in another centralized system or even in the public network.

An embodiment for acquiring the service area information SAI will now be described with reference to FIGS. 3-5.

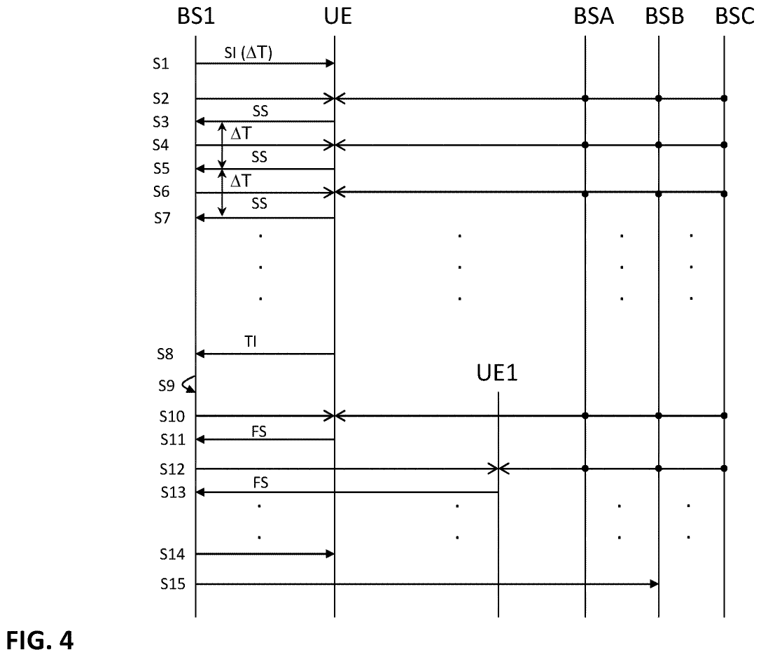

A user device UE, which may or may not be user device UE1 described above, may be set in service area definition mode. For example, the handover management system 10 is configured to send a service area definition mode start instruction SI to the user device UE in step S1 of FIG. 4. This embodiment enables control from the handover management system 10 to set the user device UE to service area definition mode. The service area definition mode instruction may include a report time interval ΔT for the user device UE to report the second sets SS of radio signal parameter values. The report time interval ΔT may be different from regular report time intervals for handover in order to obtain an appropriate definition of the dedicated service area 2. As another example, a user may set user device UE in service area definition mode through interaction with the user device UE. To that end, the user device UE may be configured with program code C to enable this mode by showing a menu on the screen S as shown in FIG. 5. User device UE may be configured to store in memory M one or more second sets SS with measured radio signal parameters x.

In service area definition mode, the user device UE measures radio signal parameter values while moving, for example approximately along the desired perimeter of the dedicated service area as shown by the dashed line in FIG. 3. The radio signal parameter value measurements are shown by steps S2, S4, S6 in FIG. 4. For example, at the start location in the top right corner, the user device UE may measure radio signal parameter value x5 from dedicated base station BS1, x6 from public base station BSA, x7 from public base station BSB and x8 from public base station BSC to form a second set SS. Some further second sets SS are also shown in FIG. 3. It should be appreciated that (many) more second sets may be acquired by the user device UE.

If the report time interval ΔT is implemented, measurements of radio signal parameter values are reported at this time interval as shown. In steps S3, S5 and S7, the UE reports the second sets of values SS for the various locations of the user device to the serving dedicated base station BS1. It should be noted that it is not necessary to report individual second sets SS of values to the serving base station as shown in FIG. 4. The user device UE may store second sets SS (or values allowing construction of the second set SS) of radio signal parameter values in memory M of the user device (FIG. 5), which may be beneficial when the connection with the serving base station is (temporarily) lost.

Serving base station BS1 in service area definition mode is configured to disable handover for the UE during this mode. Hence, when definition of the service area is in progress, the handover management system 10 does not command the user device UE collecting the second sets SS of radio signal parameter values to connect to a public base station BSA-BSC but to maintain connection to the dedicated base station BS1 so that the handover management system 10 may collect the second sets SS and report these via the dedicated base station BS1.

Measurements (and reporting of the associated second sets SS of values) may be repeated as long as service area definition mode is in operation.

When service area definition mode is finished, the user device UE may indicate this to the serving dedicated base station BS1 in a service area definition mode termination indication TI in step S8. Step S8 may be triggered by the user of the user device UE operating a menu item on screen S of user device UE for transmitting a service area definition mode termination instruction TI.

Other implementations for terminating the service area definition mode are envisaged, such as terminating the mode from the network based on one or more of expiry of a timer and on an analysis of the second sets of parameters. For example, when radio signal parameter values of the second sets stay within a particular value range for a certain period of time, the handover management system may decide to terminate the service area definition mode or to send a request to the terminal to end the service area definition mode.

The radio signal parameter values of the first and second sets FS, SS may comprise reference signal received power, RSRP, measurements. RSRP measurements (typically expressed in dBm) are frequently used in telecommunications for handover decisions and provide for a relatively simple implementation for the handover management system 10. It should be appreciated that other parameters may be used as an alternative or in addition, such as reference signal received quality, RSRQ, and/or reference signal signal-to-interference (RS-SINR), typically expressed in dB, to determine location of the user device, although some additional processing of these parameter values may be required.

In step S9, the handover management system processes the received second sets of radio signal parameter values to obtain the service area information SAI to estimate location of a user device UE or UE1 for controlling handover.

The handover management system 10 may be configured to use service area information that may comprise a machine learning model. The model may be trained using at least the second sets SS of radio signal parameter values obtained from user device UE. In this manner, the model may estimate when the user device UE1 is outside the dedicated service area by inputting the first set FS of radio signal parameter values in the trained machine learning model and the output indicates whether the first user device is located outside the dedicated service area 2. The machine learning model may be applied to obtain more accurate estimations of the location of the user device UE1 vis-à-vis the dedicated service area 2. Application of the model may, for example, be useful when higher accuracy is required or for more complicated dedicated service areas.

The output of the machine learning model is a binary output indicating location of the first user device inside or outside of the dedicated service area 2. For example, the user may use user device UE and walk around the building 2 through the garden 4 to measure radio signal parameter values for a third set of values representative of location outside the dedicated service area. In this mode, the user device UE may be connected to one or more public base stations and store the third sets of radio signal parameter values for BS1 and BSA-BSC in memory M and report these third sets to the handover management system at a later point in time when connected to base station BS1.

Alternatively, the user device UE may remain connected to the dedicated base station BS1 but having a bad connection of even being temporarily disconnected, in which case temporally storing the third sets of parameter value in the user device UE would be beneficial.

The model may be trained in addition using at least the third sets of radio signal parameter values of the at least one dedicated base station BS1 and the public base stations BSA-BSC outside of the dedicated service area. It should be appreciated that for gathering the third sets of radio signal parameter values, the first user device or other user device may assume a different service area definition mode than for registering the dedicated service area.

Alternatively, the handover management system 10 may be configured to use service area information SAI that may comprise a representation of the second sets SS of radio signal parameter values enabling evaluation against the first set FS of radio signal parameter values to estimate location of the first user device is outside the dedicated service area. In this embodiment, the second sets SS of radio signal parameters may be processed with one or more mathematical operations to obtain the service area information SAI. The service area information may, for example, comprise values, boundary values, intervals, or any other representation suitable to define the dedicated service area and to estimate location of the user device vis-à-vis the dedicated service area. An example of this will be described below with reference to FIGS. 6A and 6B.

When the service area definition mode is terminated and the second sets of radio signal parameter values have been processed, user device UE continues measuring radio signal parameter values from the base stations BS1 and BSA-BSC as indicated in step S10. The user device UE reports these values as a first set FS of radio signal parameter values to the serving base station BS1 in step S11. When the handover management system 10 estimates that the user device UE1 is located in the dedicated service area 2 based on the first set FS of parameter values obtained in step S11, communication with the dedicated base station BS1 is even maintained when the radio signal parameter values x of the public network, i.e. base station BSA, BSB or BSC, for the user device UE indicate that a better radio connection would be available with the public network. The same is true for another user device UE1 that has not participated in obtaining the service area information SAI, steps S12 and S13. These measurements and reporting to the handover management system 10 continue to enable estimation of the location of the user devices UE and UE1.

At some point in time, the handover management system 10 may estimate location of the user device UE not to be inside of the dedicated service area 2. The handover management system 10 may perform an analysis of the signal strengths for each of the base stations according to the prior art within the first set FS and find that, for example, public base station BSB provides the best connection. Steps S14 and S15 indicate signaling from the handover management system 10 to the user device UE and the public base station BSB to prepare for handover.

The user device, as depicted in FIG. 5, is particularly suitable for use with the handover management system 10. The user device UE is configured to be set to the service area definition mode for transmitting the second sets SS of radio signal parameter values to the handover management system 10. The user may traverse a trajectory with a user device UE in service area definition mode in the wireless coverage area of the dedicated network to define, for example, the dedicated service area 2. During this operation, the user device UE may gather several second sets SS of radio signal parameter values, such as RSRP values, from both one or more dedicated base stations BS1 and from one or more public base stations BSA-BSC, and report these to the handover management system 10. The handover management system 10 may subsequently process these values for obtaining the service area information as described above. The user device UE may be configured to assume the service area definition mode in response to at least one of a service area definition mode instruction from the handover management system 10 (step S1 in FIG. 4) and a user input on the user device.

FIGS. 6A and 6B illustrate a practical example for use of the handover management system 10 in a home network and the user device UE for obtaining the service area information SAI.

The dedicated base station BS1 is configured to broadcast the Closed Access Group (CAG) ID which is provisioned in the UEs belonging to the home so other user devices do not attempt to access the home network and the home UEs can distinguish when the cell is part of the home network. It should be appreciated that other solutions to make user devices aware of differences between public base stations and dedicated base stations have been envisaged, including configuring cell ID's of the dedicated base stations in the handover management system.

The UE may measure an RSRP value RSRP1 related to the dedicated base station BS1. Simultaneously, the home location is also within coverage of a public network so that the user device UE will measure, for example RSRP2, RSRP3 and RSRP4 for base station BSA, BSB and BSC, respectively.

For the dedicated network, good radio planning is assumed, i.e., the dedicated base station BS1 is well placed such that it is able to offer optimal signal strength to the UEs within the entire physical area of the home 2.

During a service area definition phase, RSRP values of the base stations are recorded while the user device UE goes through the physical area of the home such that for several locations within the home, values of RSRP can be recorded. This can be done by means of the user walking around the house with the user device UE such that values can be recorded and stored. It should be appreciated that it is not needed that the location itself is recorded but only the radio signal parameter values are measured and assembled in sets {RSRP1, RSRP2, RSRP3, RSRP4} with values shown x5-x20 as shown in FIG. 3. These values may serve as a sort of a coordinate system, despite that their values may not be decreasing linearly with the increase of distance due to the nature of wave propagation.

Once the RSRP values have been measured in service area definition mode and stored, and possibly processed, a value set may be created and boundary values for the four different RSRPs may be identified to represent the dedicated service area. Using a combination of these values may enable estimation whether the UE is within the service area or not (which corresponds to the rest of the values which are not in the table of FIGS. 6A, 6B). Since the user device UE regularly reports the RSRP values for the base stations, an algorithm running in handover management system may fetch the RSRP values for the relevant base stations, cross-reference this to the value set that was initially recorded in service area definition mode to estimate whether the user device UE1 is in the home area or outside. For example, if the values of the first set FS fall into the intervals designated as in-premises, the dedicated base station BS1 will not initiate a handover even if one or more public base stations BSA-BSC have better RSRP than the RSRP of a dedicated base station BS1. Otherwise, the UE is found to be outside the home area and the dedicated base station BS1 will initiate a handover towards the public base station as usual based on the signal strength (RSRP).

It should be appreciated that, while the example of FIGS. 6A and 6B employs four base stations which is appropriate for good three-dimensional space positioning, the disclosed system may be used with fewer base stations for reference. However, the more base stations can be measured by the UE, the more reference points for decision and the more accurate the decision may be especially with regards to the positioning within a 2D plane or 3D space. Furthermore, with the progress of advanced antenna systems and other similar solutions for base stations, it should be appreciated that the actual signal strength shows even more variation but if best values are taken (i.e. from the best possible beam of each base station) appropriate results may still be obtained.

As shown in FIGS. 6A and 6B, the base stations may broadcast their Cell IDs and the dedicated base station may also broadcast its CAG ID. A Closed Access Group identifies a group of subscribers who are permitted to access one or more CAG cells associated to the CAG. CAG is used to prevent UE(s), which are not allowed to access the associated cell(s), from automatically selecting and accessing the associated CAG cell(s). To use CAG, the UE, that supports CAG as indicated as part of the UE 5GMM Core Network Capability, may be pre-configured or (re)configured with the following CAG information, included in the subscription as part of the Mobility Restrictions.

In operation, the user device UE is connected to the dedicated base station BS1 and is configured by the dedicated base station BS1 to send measurement reports at a specific time interval. The UE and dedicated base station BS1 are put into service area definition mode, which is a calibration mode of the UE and dedicated base station BS1 in order to define the dedicated service area for the handover management system algorithm. The service area definition mode is executed by the user device sending regular measurements for all the measurable base stations, optionally including their CAG IDs (if they belong to the same CAG as the currently serving dedicated base station BS1, otherwise the measurement is discarded since it belongs to another group/home). In this state the dedicated base station BS1 does not initiate handovers to a public base station for this user device UE at all. This mode can be either triggered by an action taken by the user of the UE (i.e. by activating a function in a menu on the device as shown in FIG. 5), or by the base station with a signal message (i.e. RRC reconfiguration message) as shown in FIG. 4, step S1.

To enable setting up a baseline for the measurements within the home area, the user of the user device UE moves through the home area that needs to be defined while the user device UE keeps sending measurements at regular intervals. The user may be informed that this activity needs to be undertaken to define the dedicated service area. The interval length of the measurements is either set by the dedicated base station in, for example, an RRC reconfiguration message, or configured by the user in the UE, depending on the trigger mentioned above. The measurements contain at least an indication of signal strength (in the form of RSRP or other indications like RSSI, SINR, etc.) and Cell ID for each of the four base stations (including CAG IDs, if applicable). The trajectory of the user device UE is depicted with a dashed line in FIG. 6A. In general, the user needs to allow the user device UE to perform measurements in relevant areas where he/she wants to define ‘the home area’, especially along the borders between the home area 2 and possibly outside (e.g. in the attic, near windows, in the garden 4).

When the dedicated base station BS1 receives all these measurements, the measurements are stored in, for example, a table as depicted in FIGS. 6A, 6B in a handover management system (not shown individually in these figures). After traversing the premises is finished, indicated either by the user or automatically by the user device UE (i.e. by storing all the samples and analyzing that no new samples are present anymore) the user device UE sends a message to the dedicated base station BS1 that the data is collected (see also step S8 in FIG. 4) and the service area definition mode can be terminated.

After collecting all the data, the handover management system at the dedicated base station BS1 processes the data and may, for example, determine value ranges by taking the minimum and maximum RSRP for each base station that fall in the home area. For the three sample table for locations 1, 2, 3 in FIG. 6A, these intervals are RSRP1=(−141,−62), RSRP2=(−149,−54), RSRP3=(−200,−124) and RSRP4=(−210,−105). This is a simple calculation and assumes a linear relationship between distance and signal strength which may be sufficient for certain arrangements. It should be appreciated that the accuracy requirement is not necessarily as stringent as with UE positioning. The simplicity is an advantage and may cater widespread use. If more stringent requirements are set, a more elaborate algorithm may be used or a machine learning model may be applied as described above.

In practical situations, complexities may arise from the actual physical environment, frequencies used and other variables. Another complexity is the advent of non-omnidirectional antenna solutions and beamforming. In order to gain accuracy and capture the actual relation, supervised Machine Learning algorithms for binary classification may be helpful. Binary classification refers to classification tasks that have two class labels and popular algorithms to do this are Logistic Regression, k-Nearest Neighbors, Decision Trees, Support Vector Machine, Naive Bayes and others. Two class labels appropriate for the disclosed solution are service area=Yes and service area=No. The training data for service area=Yes label has been already collected with the traversal of the UE across the service area as illustrated in FIG. 6A. Training data may also be needed for the label service area=No, for otherwise there may be not enough information for the algorithm to generate a boundary.

This training data can be generated in a second run following the first in-premises traversal with the user device UE being outside of the service area border. In this embodiment, the dedicated base station may send a message to the user device UE to start the ‘Premises Border Definition Mode’ (e.g. after step S9 in FIG. 4), which may pop up as a prompt to the user on the screen S of the user device UE and request for input when to start the data collection. After the user initiates this mode, the traversal of the user device UE outside of the service area starts and data is collected in the same manner as previously but this time with a different label-service area=No. During this process, third sets of radio signal parameters are measured, but, since the coverage of the dedicated base station BS1 is optimized for the premises, the user device UE may lose connectivity with the dedicated base station BS1 (since handovers to non CAG-ID base stations are not permitted) and may not be able to send regular RRC measurement reports. In this case, the user device UE may use memory M to store the radio signal parameter values and send them in a batch whenever connectivity is re-established by the lower layers with dedicated base station BS1. Alternatively, the UE in the premises border definition mode may be forced to communicate with dedicated base station BS1 only and may use memory M to store the third sets if communication with the dedicated base station BS1 is temporarily not possible.

When the process is complete, the dedicated base station BS1 may use the combined dataset with service area=Yes and service area=No labels to train a supervised ML algorithm which outputs a classifier for handover decisions.

When this measurement process is complete and dedicated service area information is available, the dedicated base station BS1 and the user device UE leave the service area definition mode and switch to normal operation by using these ranges in the handover decision. The user device UE keeps sending regular measurement reports as usual. This is described in clause 9.2.3.2 from 3GPP TS 38.300. During this normal operation, when the dedicated base station BS1 senses that a handover needs to be initiated towards a Cell ID with no CAG ID, the handover management system does an additional check and takes the measurement reports for the three public base stations BSA-BSC as described above and checks whether the four values (including its own) correspond within the calculated (or defined) premises values or intervals. If the outcome is positive, then the user device is still considered on premises and a handover is not initiated.

For example, when a user device UE1 is in position 4 shown in FIG. 6B, the first set of RSRP values reported to dedicated base station BS1 may indicate that public base station BSA offers a better connection than dedicated base station BS1. The first set FS may, for example, comprise {−130, −110,−170,−140}, all values are in the service area information interval, so that the user device UE1 is still considered on premises. If UE1 moves out of the service area as shown in FIG. 6B, the first set FS of reported values will no longer fall within the intervals and the user device UE1 may be handed over in the known manner.

Dedicated network(s) with a large service area and dedicated network(s) having higher frequency base stations may have deployed a plurality of dedicated base stations.

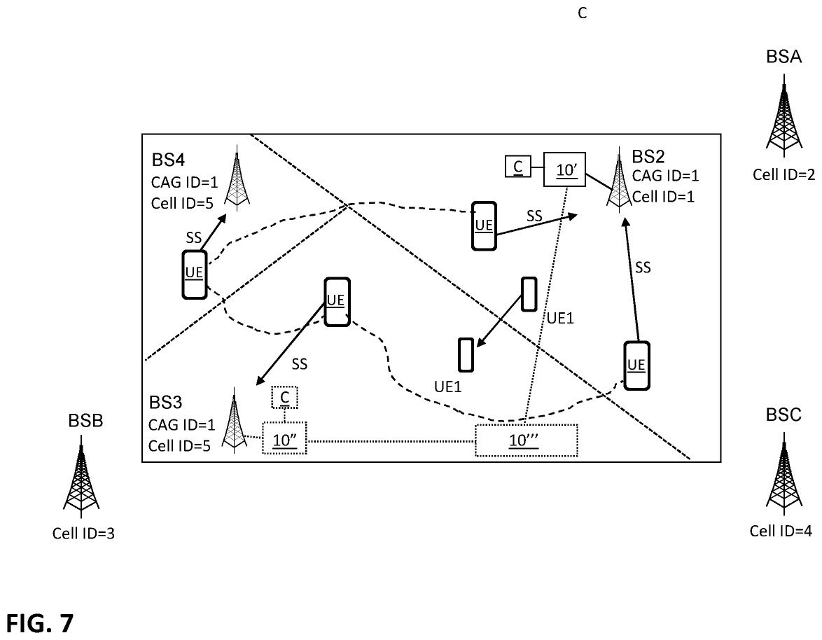

FIG. 7 is a schematic illustration of an embodiment of a handover management system for a dedicated network comprising a first dedicated base station BS2 and a second dedicated base station BS3. More dedicated base stations BS4, BS5 (not shown), . . . may be deployed for a dedicated network.

The handover management system comprises a handover manager 10′that may be configured to initiate handover of the first user device UE1 from the first dedicated base station BS2 to the second dedicated base station BS3 based on receiving a first radio signal parameter value for the first dedicated base station and a second radio signal parameter value for the second dedicated base station and comparing these values. This may occur when user device UE1 approaches base station BS3 as shown in FIG. 7. The embodiment allows handover between dedicated base stations BS2, BS3 to be performed according to conventional handover mechanisms, so that user devices UE communicating within the dedicated network may be served by the dedicated base station with the best radio connection. Again, as within public networks, a threshold may be applied to avoid frequent handover between dedicated base stations when a user device measures approximately equal radio signal parameter values. Handover manager 10′ may detect internal handover within the dedicated network as a result of the UE1 reporting the CAG ID or a cell ID for which the handover system is aware that this cell ID is associated with a dedicated base station.

The service area definition mode to decide on handover to the public network may need to be adapted to the situation wherein multiple dedicated base stations are deployed.

The handover management system may be configured to be set to service area definition mode to acquire the second sets of radio signal parameter values. The first dedicated base station BS2 may be configured to communicate setting to the service area definition mode to the second dedicated base station BS3. Such communication may be conducted over direct connections between the dedicated base stations BS2, BS3 or via the public network. The embodiment facilitates service area definition mode to be started for all dedicated base stations BS2, BS3 of the dedicated network. Such service area definition mode behavior comprises collecting and/or processing second (and possibly, third) sets of radio signal parameter values to define the dedicated service area, for example by training a machine learning model or to obtain a representation of such a dedicated service area.

In one example, all dedicated base stations BS2, BS3 of the dedicated network may be a part of a closed access group (CAG) and broadcast a CAG ID to the user device UE, UE1 as shown in FIG. 7. All the user devices UE, UE1 within the service area may be configured with an ‘allowed CAG list’, such that the UE, UE1 can identify which dedicated base stations within the area are available for access. Along with the RSRP values recorded from all public and dedicated base stations, the user device UE may also report the associated CAG IDs to the serving dedicated base station in service area definition mode.

Moreover, the user device UE may be configured to receive and process one or more identifiers, such as the CAG ID or CAG IDs and/or the list of cell IDs of the dedicated base stations BS2, BS3, BS4. This information may be used to determine dedicated base stations during service area definition mode for which radio signal parameter values for the second sets are measured. The identifier or identifiers may be contained in a service area definition mode instruction.

While conducting the measurements, when the user device UE in service area definition mode is moving around within the intended service area, and moves away from dedicated base station BS2, RSRP1 will become weaker than the signal from another dedicated base station BS3 associated with value RSRP5. Before initiating handover to BS3, handover manager 10′ may check if the stronger signal for BS2 has an associated CAG ID. If yes, this means that the dedicated base station BS2 is associated with the same service area and handover may be initiated based on RSRP1 and RSRP5 (using a threshold for hysteresis, if applied). While initiating the handover, the handover manager 10′ of serving dedicated base station BS2 may also send an indication to the new serving dedicated base station BS3 that the user device UE is in service area definition mode. The dedicated base stations BS2, BS3 may have Xn interfaces between each other so this would be an Xn handover in which case this indication may be sent over Xn. In the case of N2 handovers, however, the same indication can be transported over N2 via the AMF of the core network 1. This is also a valid procedure and also applies to a dedicated network with more than two dedicated base stations.

The handover management system may store, use or distribute the second sets of radio signal parameter values in various ways.

For dedicated networks comprising more than one dedicated base station BS2, BS3, the first dedicated base station BS2 and the second dedicated base station BS3 may be configured to store the second sets SS of radio signal parameter values received from the first user device UE1 or another user device UE at least during service area definition mode using handover managers 10′ and 10″. Since a user device UE reports the second sets SS of radio signal parameter values to the serving dedicated base station, both the first dedicated base station and the second dedicated base station may receive second sets of radio signal parameter values. To define the dedicated service area, it is advantageous that the dedicated base stations BS2, BS3 of the dedicated network store these values to allow defining the dedicated service area when the user device has finished the service area definition mode.

Furthermore, the first dedicated base station BS2 and the second dedicated base station BS3 may exchange second sets SS of radio signal parameter values with each other. The embodiment enables each dedicated base station BS2, BS3 to obtain all the second sets of radio signal parameter values for the dedicated base stations of the dedicated network, so that each individual base station BS2, BS3 can obtain the service area information for the full service area and decide on handover to the public network based on the defined dedicated service area. Base station BS3 is provided with a local handover manager 10″ as part of the handover management system.

The first dedicated base station BS2 and the second dedicated base station BS3 may also send the second sets of radio signal parameter values to a central handover manager 10″ or to the user device UE. This facilitates centralization of the service area information for centralized handover management or enables distribution of the second sets of radio signal parameter values by the user device UE. For example, for dedicated base station BS4 not having a handover manager, user device UE may store the second sets and make them available to central handover manager 10″, for example.

Moreover, the first dedicated base station BS2 may be configured to obtain service area information representative of a dedicated service area of the first dedicated base station of the dedicated network on the basis of the received second sets SS of radio signal parameter values. Likewise, the second dedicated base station BS3 may be configured to obtain service area information representative of a dedicated service area of the second dedicated base station of the dedicated network on the basis of the received second sets SS of radio signal parameter values. This embodiment facilitates decentralized handover control using handover managers 10′ and 10″ separately by making only a part of the service area information available to a particular dedicated base station BS2, BS3, so that a decentralized handover management system can be performed.

For example, when a handover manager 10′, 10″ and/or 10″′ of the handover management system determines that a handover is to be initiated to a base station with a cell ID that has not CAG ID and/or is not part of a list of cell IDs of dedicated base stations of the dedicated network, the handover management system may perform an additional check by referencing the first set FS of radio signal parameters of UE1 against the dedicated service area information to estimate whether the UE1 is still within the dedicated service area. If the outcome is positive, then the user device UE1 is still considered on premises and a handover is not initiated. However, towards dedicated base stations with the same CAG ID or on the list of cell IDs of dedicated base station, handovers are performed in a normal RSRP check manner following the current standard.

Termination of the service area definition mode enables activating the handover management system to decide on handover of the user device based on the service area information by estimating the location of the user device.

In FIG. 7, dedicated base stations BS2, BS3 may be aware of each other's existence in the dedicated network. Hence, when the service area definition mode is terminated, a termination signal or indication may be sent or forwarded to all dedicated base stations BS2, BS3 such that normal operation can start, and a handover decision can be made based on the defined dedicated service area. For example, when user device UE sends a termination signal to dedicated base station BS2, handover manager 10′ may send this signal to handover manager 10″ of dedicated base station BS3 and/or any other handover manager of a dedicated base station of the dedicated network.

If the dedicated network is configured such that the dedicated base stations or the handover management system are not aware of each other's existence in the network, a termination indication from a user device UE to a serving dedicated base station may not reach all dedicated base stations. This may apply in a dedicated network having three or more dedicated base stations. To that end, the handover management system may be configured to store information C from which dedicated base station a user device UE entered a cell of a dedicated base station BS2, BS3, BS4 in service area definition mode and forwarding a service area definition mode termination indication in accordance with the stored information. The embodiment enables propagation of the service area definition mode termination indication back along and in the order of the dedicated base stations to which the user device UE connected in service area definition mode, when the user device UE sends the service area definition termination instruction to the dedicated base station to which it is connected upon termination. In this manner, the termination indication may be received by all dedicated base stations BS2, BS3, BS4 without a need to configure the dedicated network such that the dedicated base stations are aware of each other's existence.

In one example, it may occur that the user device UE comes back to the initial dedicated base station BS3 after having reported second sets SS of radio signal parameters to dedicated base station BS2, BS3, BS4, BS3. In this case, the process of reporting second sets SS continues as described before and each base station stores the information from which dedicated base station the UE entered the cell of the dedicated base station, for the example given base station BS3 stores BS2 for the first time and BS4 for the second time and BS4 stores BS3, in service area definition mode. Whenever the UE completes the traversal of the premises it sends a message to the currently serving base station, i.e. dedicated base station BS3 in this example. However, since user device UE traversed all dedicated base stations, this notification has to reach all dedicated bases stations BS2, BS3, BS4 to terminate the service area definition mode and to start normal operation. After base station BS3 has received the termination indication, it uses the second stored information for the UE and reports this to base station BS4 from which the user device was handed over during service area definition mode the second time. Base station BS4 provides the termination indication back to base station BS3, which has a second stored information for this UE, in this case base station BS2. To that end, the stored information C enables the termination indication to propagate from the dedicated base station via each hop that the UE traversed in the dedicated network, by indicating that further handovers were performed during service area definition mode. When the indication has reached BS2, all dedicated base stations have been reached and may process the second sets to derive, for example, the RSRP intervals (each with its own collected data) and release the UE context.

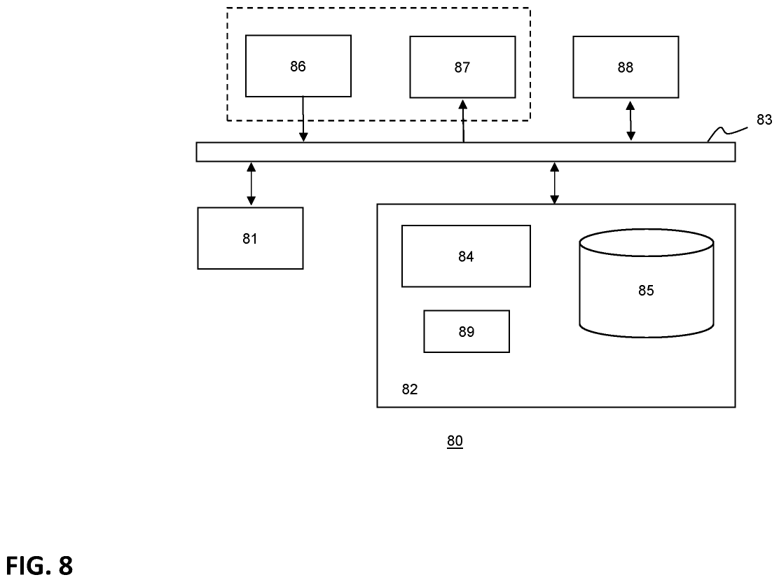

FIG. 8 depicts a block diagram illustrating an exemplary processing system according to a disclosed embodiment, e.g. a handover management system 10 or a user device for use with such a handover management system as disclosed herein. As shown in FIG. 8, the processing system 80 may include at least one processor 81 coupled to memory elements 82 through a system bus 83. As such, the processing system may store program code within memory elements 82. Further, the processor 81 may execute the program code accessed from the memory elements 82 via a system bus 83. In one aspect, the processing system may be implemented as a computer system that is suitable for storing and/or executing program code. It should be appreciated, however, that the processing system 80 may be implemented in the form of any system including a processor and a memory that is capable of performing the functions described within this specification.

The memory elements 82 may include one or more physical memory devices such as, for example, local memory 84 and one or more bulk storage devices 85. The local memory may refer to random access memory or other non-persistent memory device(s) generally used during actual execution of the program code. A bulk storage device may be implemented as a hard drive or other persistent data storage device. The processing system 80 may also include one or more cache memories (not shown) that provide temporary storage of at least some program code in order to reduce the number of times program code must be retrieved from the bulk storage device 85 during execution.

Input/output (I/O) devices depicted as an input device 86 and an output device 87 optionally can be coupled to the processing system. Examples of input devices may include, but are not limited to, a space access keyboard, a pointing device such as a mouse, or the like. Examples of output devices may include, but are not limited to, a monitor or a display, speakers, or the like. Input and/or output devices may be coupled to the processing system either directly or through intervening I/O controllers.

In an embodiment, the input and the output devices may be implemented as a combined input/output device (illustrated in FIG. 8 with a dashed line surrounding the input device 86 and the output device 87). An example of such a combined device is a touch sensitive display, also sometimes referred to as a “touch screen display” or simply “touch screen” that may be provided with the UE. In such an embodiment, input to the device may be provided by a movement of a physical object, such as e.g. a stylus or a finger of a person, on or near the touch screen display.

A network adapter 88 may also be coupled to the processing system to enable it to become coupled to other systems, computer systems, remote network devices, and/or remote storage devices through intervening private or public networks. The network adapter may comprise a data receiver for receiving data that is transmitted by said systems, devices and/or networks to the processing system 80, and a data transmitter for transmitting data from the processing system 80 to said systems, devices and/or networks. Modems, cable modems, and Ethernet cards are examples of different types of network adapter that may be used with the processing system 80.

As pictured in FIG. 8, the memory elements 82 may store an application 89. In various embodiments, the application 89 may be stored in the local memory 84, the one or more bulk storage devices 85, or apart from the local memory and the bulk storage devices. It should be appreciated that the processing system 80 may further execute an operating system (not shown in FIG. 8) that can facilitate execution of the application 89. The application 89, being implemented in the form of executable program code, can be executed by the processing system 80, e.g., by the processor 81. Responsive to executing the application, the processing system 80 may be configured to perform one or more operations or method steps described herein.

In one aspect of the present invention, one or more components of the handover management system and/or user device for use with such a handover management system. as disclosed herein may represent processing system 80 as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 81 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration but is not intended to be exhaustive or limited to the implementations in the form disclosed. Many modifications and variations will be apparent to those of ordinary skill in the art without departing from the scope of the claims. The embodiments were chosen and described in order to best explain the principles and some practical applications of the present invention, and to enable others of ordinary skill in the art to understand the present invention for various embodiments with various modifications as are suited to the particular use contemplated.

1. A handover management system for managing handover of a first user device between a dedicated network comprising at least one dedicated base station and a public network comprising a plurality of public base stations, wherein wireless coverage areas of the dedicated network and the public network overlap at least in part, wherein the handover management system comprises:
a receiving system configured to receive a first set of radio signal parameter values from the first user device for the at least one dedicated base station and at least one public base station of the plurality of public base stations;
wherein the handover management system contains service area information representative of a dedicated service area of the dedicated network defined on the basis of a plurality of second sets of radio signal parameter values of the at least one dedicated base station and the at least one public base station, and;
wherein the handover management system is configured to initiate handover of the first user device from the dedicated network to the public network only when the first set of radio signal parameter values indicates location of the first user device is outside the dedicated service area based on the service area information.

2. The handover management system according to claim 1, wherein the service area information comprises:
a machine learning model, wherein the model is trained using at least the second sets of radio signal parameter values, wherein the first set of radio signal parameter values is input to the trained machine learning model and the output indicates whether the first user device is located outside the dedicated service area; or
a representation of the second sets of radio signal parameter values enabling evaluation of the first set of radio signal parameter values to estimate whether the first user device is located outside the dedicated service area.

3. The handover management system according to claim 2, wherein the output of the machine learning model is a binary output indicating location of the first user device inside or outside of the dedicated service area and the model is trained in addition using at least a third set of radio signal parameter values of the at least one dedicated base station and the at least one public base station outside of the dedicated service area.

4. The handover management system according to claim 1, wherein the handover management system is configured to acquire the second sets of radio signal parameter values for defining the dedicated service area from at least one of the first user device or another user device in service area definition mode, wherein, optionally, the handover management system is configured to send a service area definition mode instruction to the first user device or the other user device, wherein, optionally, the service area definition mode instruction provides a report time interval for the first user device or the other user device to report the second sets of radio signal parameter values.

5. The handover management system according to claim 1, wherein the handover management system is configured to be set to a service area definition mode to acquire the second sets of radio signal parameter values for defining the dedicated service area, wherein the handover management system in service area definition mode is configured to disable handover of the first user device or the other user device to the at least one public network base station.

6. The handover management system according to claim 1, wherein the dedicated network comprises at least a first dedicated base station and a second dedicated base station, wherein the handover management system is configured to initiate handover of the first user device from the first dedicated base station to the second dedicated base station based on receiving a first radio signal parameter value for the first dedicated base station and a second radio signal parameter value for the second dedicated base station and comparing these values.

7. The handover management system according to claim 1, wherein the handover management system is configured to recognize the at least one dedicated base station on the basis of a closed access group identifier, CAG ID, or a preconfigured list of dedicated cell identifiers, cell IDs, of dedicated base stations.

8. The handover management system according to claim 1, wherein at least a part of the handover management system is configured to be set to a service area definition mode to acquire the second sets of radio signal parameter values by at least one of:
receiving a service area definition mode instruction from a user device;
communicating setting the service area definition mode from the first dedicated base station to the second dedicated base station

9. The handover management system according to claim 6, comprising at least one of the following:
the first dedicated base station and the second dedicated base station being configured to store the second sets of radio signal parameter values received from the first user device or another user device at least during service area definition mode;
the first dedicated base station and the second dedicated base station exchanging second sets of radio signal parameter values with each other;
the first dedicated base station and the second dedicated base station sending the second sets of radio signal parameter values to a central location or to the user device;
the first dedicated base station obtaining service area information representative of a dedicated service area of the first dedicated base station of the dedicated network on the basis of the received second sets of radio signal parameter values and the second base station obtaining service area information representative of a dedicated service area of the second dedicated base station of the dedicated network on the basis of the received second sets of radio signal parameter values.

10. The handover management system according to claim 1, wherein the handover management system is configured to terminate the service area definition mode by at least one of the following:
receiving a service area definition mode termination instruction from a user device expiry of a definition mode timer and/or by an analysis of the second sets of radio signal parameter values;
communicating the termination of the service area definition mode from a dedicated base station to one or more other dedicated base stations of the dedicated network;
configured to store information from which dedicated base station a user device entered a cell of a dedicated base station in service area definition mode and forwarding a service area definition mode termination indication in accordance with the stored information.

11. The handover management system according to claim 1, wherein the radio signal parameter values of the first and second sets comprise reference signal received power, RSRP, measurements.

12. The handover management system according to claim 1, wherein the system is part of at least one dedicated base station.

13. A user device configured for use with a handover management system according to claim 1, wherein the user device is configured to be set to a service area definition mode for transmitting the second sets of radio signal parameter values to the handover management system, wherein, optionally, the user device is configured for transmitting at least one identifier of at least one dedicated base station, such as a closed access group identifier, CAG ID, or a group of cell IDs, to the handover management system.

14. The user device according to claim 11, wherein the user device is configured to assume the service area definition mode in response to at least one of:
a service area definition mode instruction from the handover management system;
and
a user input on the user device.

15. The user device according to claim 11, wherein the user device is configured to store sets of radio signal parameter values during service area definition mode and to send the sets to the handover management system after storage.

16. The user device according to claim 13, wherein the user device is configured to receive and process at least one identifier of at least one dedicated base station to determine dedicated base stations during service area definition mode for which radio signal parameter values for the second sets are measured, wherein optionally, the identifier is contained in a service area definition mode instruction.
